(19) United States
(12) Patent Application Publication
(10) Pub. No.: US 2025/0219318 A1
(43) Pub. Date: Jul. 3, 2025

(54) Housing Assembly of Connector for Installing to Mounting Panel and Connector

(71) Applicant: Tyco Electronics (Shanghai) Co., Ltd., Shanghai (CN)

(72) Inventors: Dalei (Otto) Chen, Shanghai (CN); Hongbo (Daniel) Zhang, Shanghai (CN); Bo (Leo) Chen, Shanghai (CN); Zhimin Xing, Shanghai (CN)

(73) Assignee: Tyco Electronics (Shanghai) Co., Ltd., Shanghai (CN)

(21) Appl. No.: 19/002,869

(22) Filed: Dec. 27, 2024

(30) Foreign Application Priority Data
Dec. 27, 2023 (CN) 202323600055.X
Jun. 11, 2024 (CN) 202421321795.1

(51) Int. Cl. H01R 13/52; H01R 13/502; H01R 13/516; H01R 24/66; H01R 103/00

(52) U.S. Cl. CPC H01R 13/5202; H01R 13/5025; H01R 13/516; H01R 24/66; H01R 2103/00

(57) ABSTRACT

A housing assembly of a connector for installing to a mounting panel includes an insulation housing and a sealing structure. The insulation housing has a housing body extending axially and a flange portion extending radially outward from an outer wall of the housing body. The sealing structure is fixedly retained on a side of the flange portion facing the mounting panel. The sealing structure is elastic and abuts against the mounting panel to seal a gap between the insulation housing and the mounting panel.

### CROSS-REFERENCE TO RELATED APPLICATION

This application claims the benefit of the filing date under 35 U.S.C. § 119(a)-(d) of Chinese Patent Application No. 202323600055.X, filed on Dec. 27, 2023, and Chinese Patent Application No. 202421321795.1, filed on Jun. 11, 2024.

### FIELD OF THE INVENTION

The present disclosure relates to a housing assembly of a connector and a connector including the housing assembly.

### BACKGROUND OF THE INVENTION

There is usually a gap between a mounting panel of an electrical equipment and a connector inserted into the mounting panel. Foreign objects and water can easily enter the electrical equipment through the gap, causing malfunctions.

A sealing member may be provided on the connector to seal the gap between the connector and the mounting panel. However, such a sealing member is prone to fall off the connector, especially during transportation before the connector is installed, which can result in loss of the sealing member.

### SUMMARY OF THE INVENTION

A housing assembly of a connector for installing to a mounting panel includes an insulation housing and a sealing structure. The insulation housing has a housing body extending axially and a flange portion extending radially outward from an outer wall of the housing body. The sealing structure is fixedly retained on a side of the flange portion facing the mounting panel. The sealing structure is elastic and abuts against the mounting panel to seal a gap between the insulation housing and the mounting panel.

### BRIEF DESCRIPTION OF THE DRAWINGS

The invention will now be described by way of example with reference to the accompanying figures, of which:

FIG. 1 shows an exploded view of a connector according to one embodiment of the present disclosure;

FIG. 2 shows a perspective view of an insulation housing of the connector according to one embodiment of the present disclosure;

FIG. 3 shows a perspective view of a sealing member of the connector according to one embodiment of the present disclosure;

FIG. 4 shows another perspective view of the sealing member of FIG. 3;

FIG. 5 shows a perspective view of the connector according to one embodiment of the present disclosure;

FIG. 6 shows a perspective view of the connector inserted into a panel of an equipment according to an embodiment;

FIG. 7 shows another perspective view of the connector of FIG. 6;

FIG. 8 shows a cross-sectional view of the connector shown in FIG. 5 taken along line A-A;

FIG. 9 shows a perspective view of an insulation housing of a connector according to another embodiment of the present disclosure;

FIG. 10 shows a perspective view of the connector according to another embodiment of the present disclosure;

FIG. 11 shows a cross-sectional view of the connector shown in FIG. 10 taken along line B-B;

FIG. 12 shows a cross-sectional view of the connector shown in FIG. 10 taken along line C-C;

FIG. 13 shows a perspective view of an insulation housing of a connector according to a further embodiment of the present disclosure;

FIG. 14 shows a perspective view of the connector according to the further embodiment of the present disclosure;

FIG. 15 shows a perspective view of a sealing member of the connector according to a further embodiment of the present disclosure;

FIG. 16 shows a cross-sectional view of the connector shown in FIG. 14 taken along line E-E;

FIG. 17 shows a perspective view of the connector before the sealing structure is formed, according to a further embodiment of the present disclosure;

FIG. 18 shows a perspective view of the connector after the sealing structure is formed, according to a further embodiment of the present disclosure;

FIG. 19 shows an end view of the connector shown in FIG. 18 when viewed towards the sealing structure;

FIG. 20 shows a perspective view of the connector shown in FIG. 18 inserted into a mounting panel of an equipment;

FIG. 21 shows a cross-sectional view of the assembly shown in FIG. 20 taken along line F-F; and

FIG. 22 shows an end view of the connector with a sealing structure according to a further embodiment of the present disclosure.

### DETAILED DESCRIPTION

Hereinafter, embodiments of the present disclosure will be described with reference to the accompanying drawings. The same reference numerals and symbols shown in the drawings of the present disclosure refer to elements or components performing substantially the same function.

Furthermore, the terminology used herein is intended to describe the embodiments, and is not intended to limit and/or constrain the present disclosure. The singular forms “a”, “an”, “the” and “said” are intended to include the plural forms as well, unless the context clearly dictates otherwise. In the present disclosure, the terms such as “include”, “comprise”, “have” and the like, are intended to specify the presence of stated features, number, steps, operations, elements, components and combinations thereof, but do not preclude the presence or addition of one or more other features, number, steps, operations, elements, components and combinations thereof.

Although the terms such as “first”, “second”, “third” and the like are used herein to describe various elements, these elements should not be limited by these terms. These terms are only intended to distinguish one element from another. For example, a first element would be termed a second element, and a second element would be termed a first element, without departing from the scope of the present disclosure. The term “and/or” includes a plurality of combinations of the associated items or any one of a plurality of associated items.

In the following detailed description, for convenience of illustration, numerous specific details are set forth in order to provide a thorough understanding of the disclosed embodiments. Obviously, however, one or more embodiments may be embodied without these specific details. In other instances, well-known structures and devices are shown in schematic form in order to simplify the drawings.

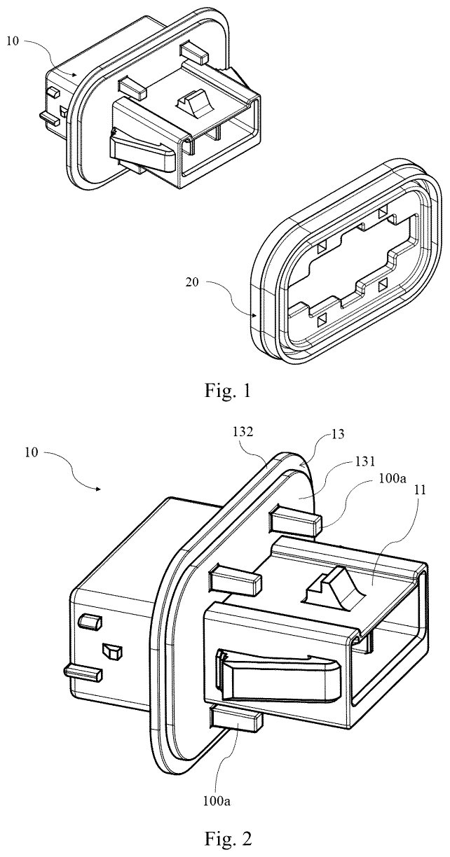

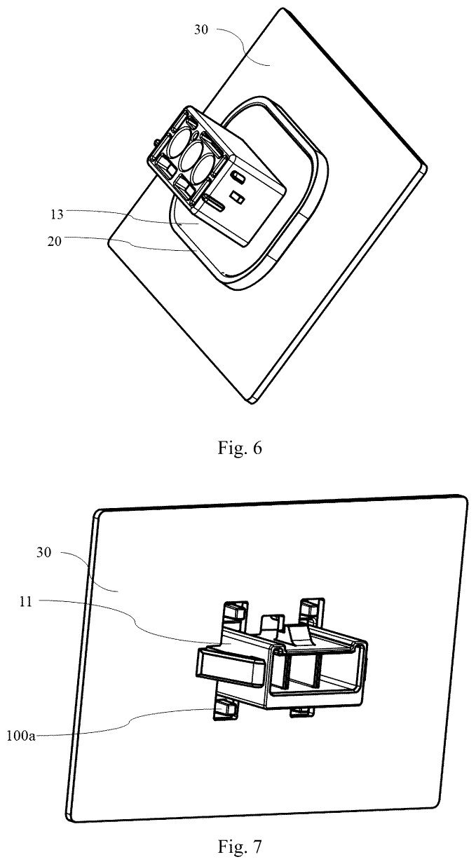

The embodiments shown in FIGS. 1 to 16 provide a housing assembly for a connector. The housing assembly includes an insulation housing 10 and a sealing member 20 adapted to be installed onto the insulation housing. The sealing member 20 may be configured to abut against a mounting panel 30 on which the connector is installed, so as to seal a gap between the insulation housing and the mounting panel. The insulation housing has a housing body 11 extending axially and a flange portion 13 extending radially outward from an outer wall of the housing body 11. The sealing member 20 is configured to surround at least a portion of the housing body 11 to be installed onto the flange portion 13. The insulation housing 10 has a retention portion(s) adapted to be engaged with the sealing member 20 to retain the sealing member on the insulation housing 10.

The connector according to the present disclosure may be an electrical connector for transmitting electrical power to an electrical equipment. In this case, the connector has a conductive terminal accommodated inside the insulation housing 10. Alternatively, the connector according to the present disclosure may be a signal connector for transmitting signals, such as optical signals, to an electrical equipment. In this case, the connector has a signal terminal or ferrule, accommodated inside the insulation housing 10. The types of the connectors in the present disclosure are not limited to the above.

The insulation housing 10 may be made of insulation material such as plastic. The sealing member 20 may be made of elastic material to have elasticity. In addition, the sealing member 20 may also be referred to as a grommet sealing member or sealing gasket.

According to various embodiments of the present disclosure, the insulation housing 10 may have the housing body 11 extending axially and the flange portion 13 extending radially outward from the outer wall of the housing body.

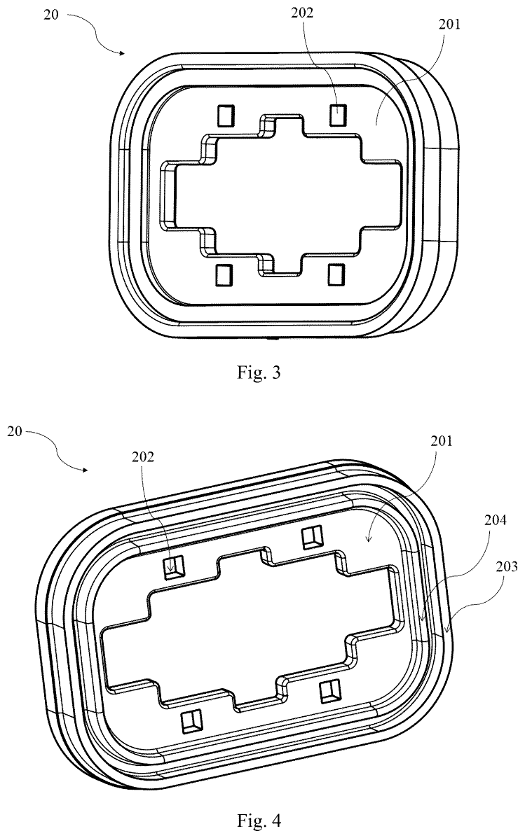

The sealing member 20 according to the present disclosure may be configured to surround at least a portion of the housing body 11 to be installed onto the flange portion 13. As shown in FIGS. 5, 10 and 14, the sealing member 20 may be configured to surround an insertion portion of the insulation housing 10 inserted into the mounting panel 30 so as to sleeve over the flange portion 13. As better shown in FIGS. 2, 5, 9 and 10, according to some embodiments of the present disclosure, the retention portions 100a, 100b extend axially from the flange portion 13 to be engaged with the sealing member 20.

In some embodiments, the sealing member 20 is adapted to abut against at least one axial surface 131 of the flange portion 13, and the retention portions 100a, 100b may protrude from the axial surface 131. In the context of the present disclosure, the axial surface is a surface of the flange portion 13 that is configured to face the mounting panel 30.

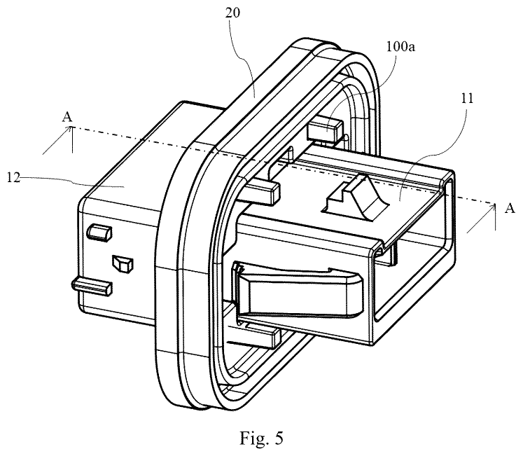

As shown in FIGS. 2, 5, 9 and 10, the retention portions according to some embodiments of the present disclosure includes a plurality of retention portions 100a, 100b protruding from the axial surface 131 in a form of a column, respectively. As shown in FIGS. 3 and 4, according to some embodiments of the present disclosure, a central portion 201 of the sealing member 20 adapted to contact with the axial surface 131 has an opening 202. The retention portion 100a, 100b is adapted to be inserted into the opening 202 so that an inner edge of the opening 202 is in frictional contact with an outer surface of the retention portion 100a, 100b. Therefore, the retention portion 100a, 100b may prevent the sealing member 20 from falling off the insulation housing 10 by the friction with the inner edge of the opening 202 of the sealing member 20.

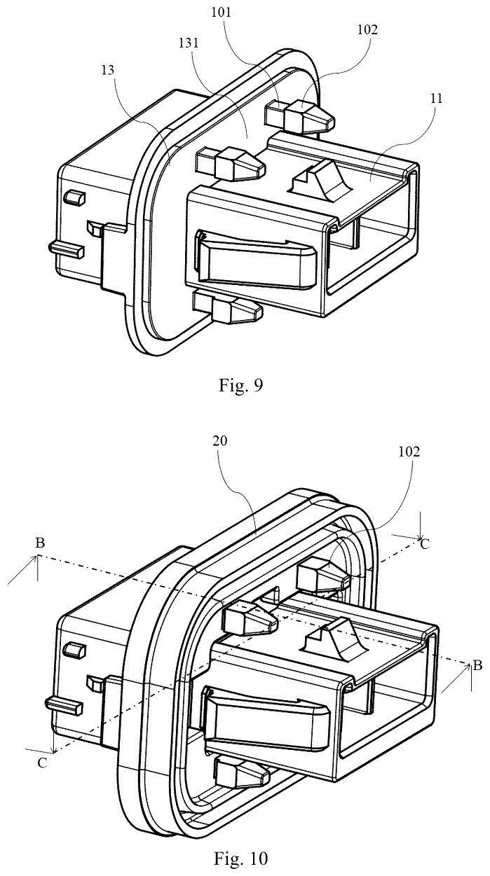

According to some embodiments of the present disclosure, the retention portions 100a, 100b may be in the form of the column and have a polygonal or circular cross-section, respectively. As shown in the embodiments of FIGS. 2 and 9, the retention portions 100a, 100b may have a quadrilateral cross-section, such as a rectangular or square cross-section, respectively.

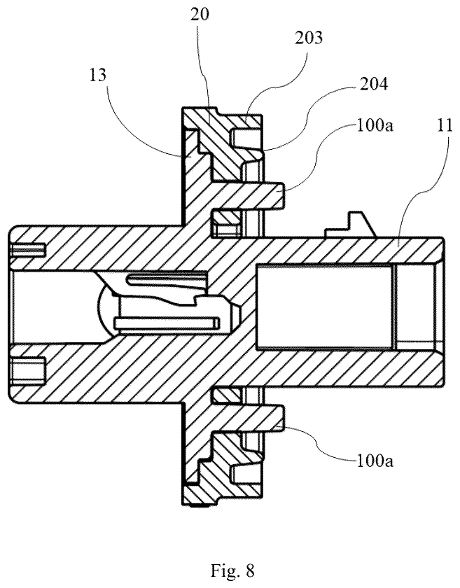

As shown in FIGS. 8, 11 and 12, in some embodiments, the retention portion 100a, 100b in the form of the column protrudes beyond the axial surface 131 by a length, which may be greater than a thickness of the central portion 201 of the sealing member 20, so that the retention portion 100a, 100b is inserted into the opening 202 in a manner such that an end of the retention portion 100a, 100b is positioned outside the opening 202.

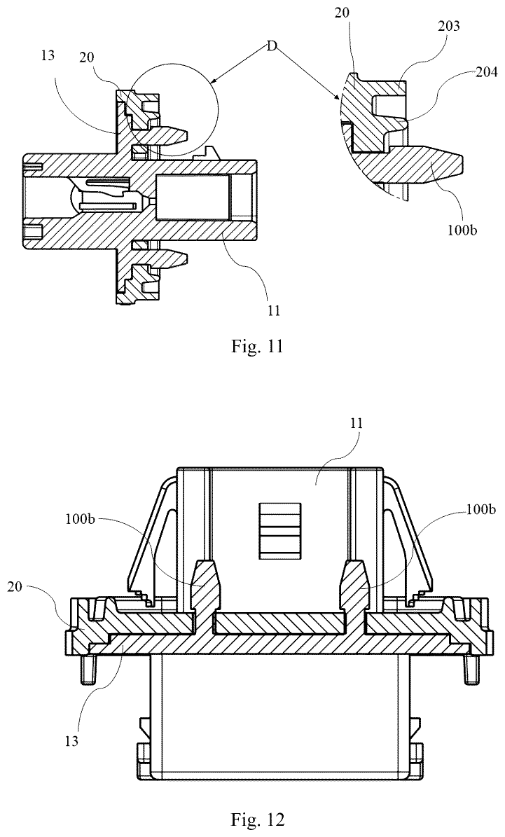

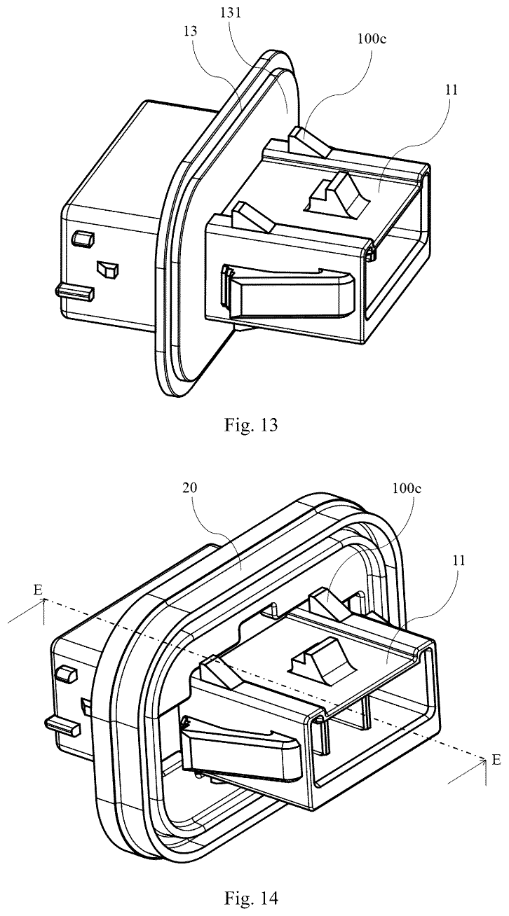

According to some embodiments of the present disclosure, as better shown in FIGS. 9 to 12, the retention portion 100b has an enlarged head 102 at a free end thereof. The enlarged head 102 can axially block the sealing member 20 from disengaging from the retention portion 100a, 100b. As shown in FIGS. 11 and 12, the central portion 201 of the sealing member 20 is adapted to be positioned between the enlarged head 102 and the axial surface 131.

In some embodiments, the enlarged head 102 may protrude radially from the column, so that a cross-sectional area of the enlarged head 102 is greater than that of the opening 202 of the scaling member. Thereby, the enlarged head 102 can axially block the sealing member 20 from disengaging from the retention portion 100b.

In some embodiments, as shown in FIGS. 9, 11 and 12, the column 101 has a quadrilateral cross-section, and the enlarged head 102 extends radially outward from three side surfaces of the column 101 except for one side surface facing the housing body 11. In other words, the side surface of the enlarged head 102 facing the housing body 11 is flat.

In some embodiments, as shown in FIGS. 9, 11 and 12, the enlarged head 102 may be formed to be tapered from a radially protruding portion of the enlarged head towards a free end of the enlarged head. In some embodiments, the enlarged head 102 is formed by a strong demolding process, so that the enlarged head 102 is tapered from the radially protruding portion of the enlarged head towards the free end of the enlarged head.

As shown in FIGS. 13 to 16, the retention portion 100c according to some embodiments of the present disclosure may at least partially protrude radially outward from an outer surface of the side wall of the housing body 11. The sealing member 20 may be configured to surround at least a portion of the housing body 11 to be installed onto the insulation housing 10, so that the sealing member 20 is adapted to be retained between the flange portion 13 and the retention portion 100c and abut against the flange portion and the retention portion 100c.

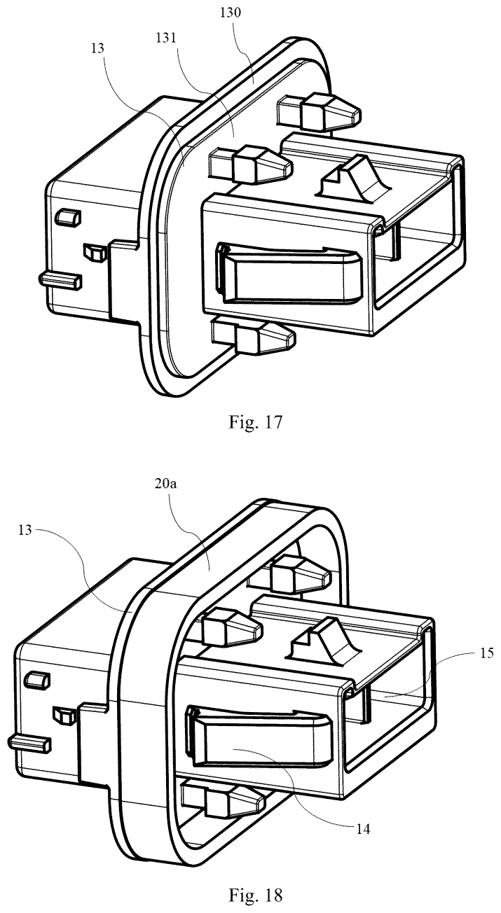

As shown in FIG. 16, the retention portion 100c may have a pressing portion 103 for pressing the sealing member 20, and the retention portion 100c is formed to be tapered from the pressing portion 103 in a direction away from the flange portion 13.

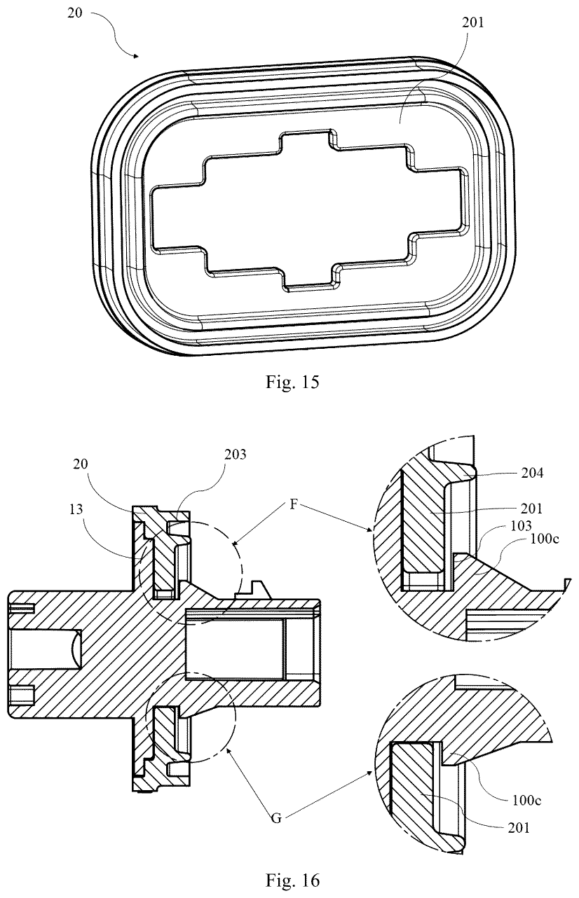

In addition, as better shown in FIG. 15, the sealing member 20 used with the retention portion 100c has only one main opening in the central portion 201 adapted to contact with the axial surface 131. The housing body 11 can pass through the main opening. The sealing member 20 used with the retention portion 100c does not have an opening similar to the opening 202 of the embodiment shown in FIG. 3.

According to various embodiments of the present disclosure, as shown in FIG. 16, the sealing member 20 may have at least two lips on a surface facing the mounting panel 30. The at least two lips may include a first lip 203 formed at an outer edge of the sealing member 20 in a circumferential direction and a second lip 204 positioned at a distance from the first lip 203.

According to the various embodiments of the present disclosure, locking portions 14 adapted to be coupled with the mounting panel 30 are formed on the outer surface of the side wall of the housing body 11 of the insulation housing 10. The locking portions 14 may include at least one pair of locking portions located on two opposite sides of the housing body 11. The at least one pair of locking portions may protrude from the outer surface of the side wall of the housing body 11 towards the flange portion 13. The locking portions 14 may be configured to lock the mounting panel 30 between the sealing structure 20, 20a and the locking portions 14. In some embodiments, the locking portions 14 may be locked in a locking opening in the mounting panel 30. In some embodiments, free ends of the locking portions 14 may abut against a panel surface of the mounting panel 30.

The sealing structure 20a or the sealing member 20 protrudes from the axial surface 131 of the flange portion 13 by a height, which may be greater than a distance between the free end of the locking portion 14 and the axial surface 131, so that the sealing structure or the sealing member can tightly and elastically abut against the mounting panel 30.

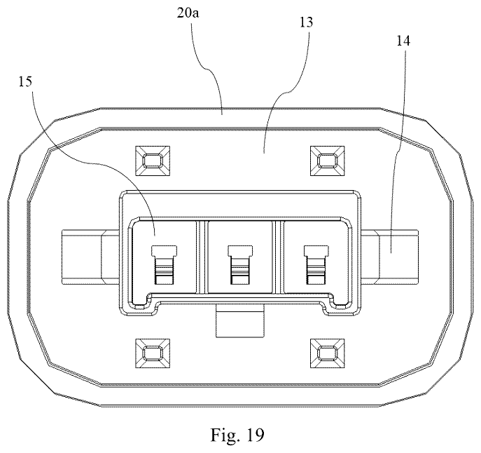

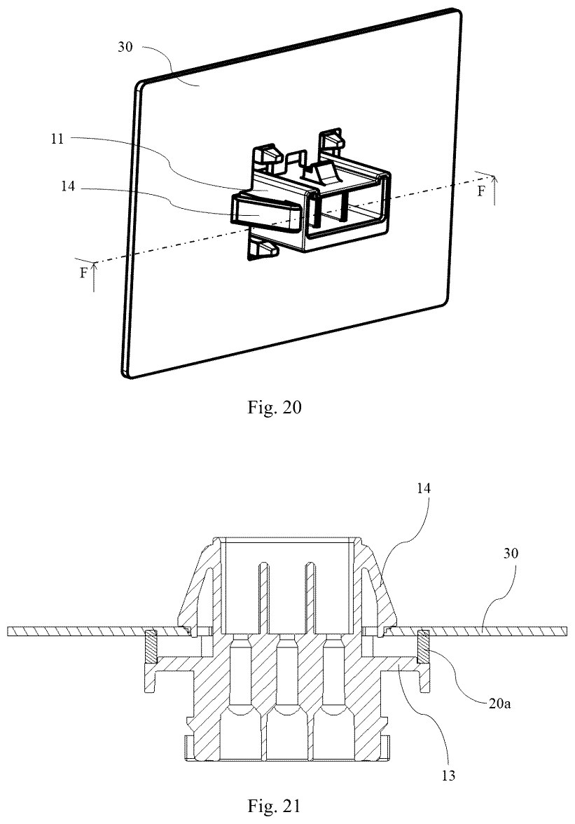

In other embodiments of the present disclosure, as shown in FIGS. 17 to 22, the sealing structure 20a may be an integral and non-removable structure integrated with the flange portion 13. Therefore, the sealing structure 20a may be firmly bonded to the flange portion 13, thereby preventing the sealing structure 20a from falling off and reducing subsequent installation steps. In this case, the retention portions 100a, 100b, 100c formed on the flange portion 13 or the housing body 11 may be omitted.

In some embodiments, the sealing structure 20a may be a cured-in-place gasket (CIPG) type of sealing structure formed by in-situ curing on the flange portion 13, which is also referred to as an in-situ cured gasket or grommet. In the process of forming the sealing structure, a liquid material different from the material of the insulation housing is applied to the flange portion 13 and is then cured, for example, by ultraviolet irradiation. The liquid material may have elasticity after being cured. For example, the material such as liquid silicone may be applied to the flange portion 13. After the liquid material is cured in situ on the flange portion 13, the sealing structure 20a that is firmly bonded to the flange portion 13 is formed. In an embodiment, the liquid material may be automatically applied by an automated dispensing equipment, thereby improving production efficiency and saving labor costs.

As shown in FIG. 17, in some embodiments, a side of the flange portion 13 facing the mounting panel 30 may have a step 130 that is recessed relative to the axial surface 131. The step 130 extends along a circumferential edge of the flange portion 13. The sealing structure 20a may be formed on the step 130. During the process of forming the sealing structure, the step 130 may define a boundary along which the liquid material is applied, thereby defining a thickness of the cured sealing structure 20A. In addition, the step 130 may increase a bonding area between the sealing structure 20a and the flange portion 13 to improve the firmness of the bonding.

In the embodiments shown in FIGS. 1 to 21, the insulation housing 10 has three accommodating cavities to accommodate three terminals such as conductive terminals, signal terminals, or ferrules.

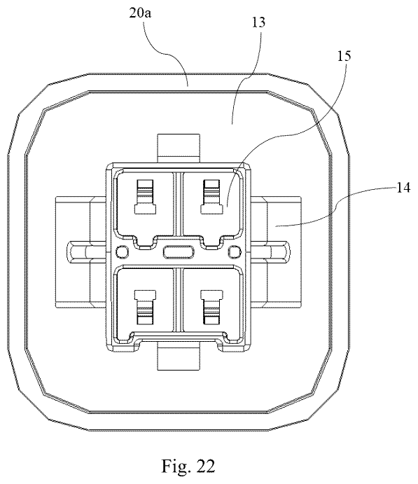

In the embodiment shown in FIG. 22, the insulation housing 10 has four accommodating cavities to accommodate four terminals. In other embodiments, the insulation housing 10 may have one, two, five or more accommodating cavities to accommodate one, two, five or more terminals. In addition, these terminals may be arranged in a row or a column, or in a plurality of rows and columns, or in various other arrangement patterns.

An embodiment of another aspect of the present disclosure provides a connector including a housing assembly according to the present disclosure and a terminal installed in the insulation housing of the housing assembly.

According to the housing assemblies and the connectors provided by the various embodiments of the present disclosure, the sealing member 20 is installed onto the outside of the insulation housing to seal the gap between the connector and the mounting panel 30 of the electrical equipment, thereby preventing foreign objects and water from entering the electrical equipment and causing malfunctions. In addition, a retention portion is provided on the insulation housing 10 of the connector to prevent the sealing member 20 from falling off the connector. In some embodiments, the sealing structure 20 located on the flange portion 13 of the insulation housing 10 is an integral and non-removable structure integrated with the flange portion 13.

Those skilled in the art would understand that the embodiments described above are all exemplary, and those skilled in the art may improve them, and the structures described in the various embodiments may be combined optionally unless they conflict in terms of structure or principle.

Although some embodiments of the present general inventive concept have been illustrated and described, those skilled in the art would understand that modifications may be made to these embodiments without departing from the principles and spirit of the present general inventive concept. The scope is defined by the claims and their equivalents.

1. A housing assembly of a connector for installing to a mounting panel, comprising:
an insulation housing having a housing body extending axially and a flange portion extending radially outward from an outer wall of the housing body; and
a sealing structure fixedly retained on a side of the flange portion facing the mounting panel, the sealing structure being elastic and abutting against the mounting panel to seal a gap between the insulation housing and the mounting panel.

2. The housing assembly according to claim 1, wherein the sealing structure is a removable sealing member formed independently of the insulation housing, the sealing member surrounds at least a portion of the housing body to be retained on the flange portion, the insulation housing has a retention portion engaging the sealing member to retain the sealing member on the insulation housing.

3. The housing assembly according to claim 2, wherein the retention portion extends axially from the flange portion and engages the sealing member.

4. The housing assembly according to claim 3, wherein the sealing member abuts against an axial surface of the flange portion facing the mounting panel, the retention portion protrudes from the axial surface.

5. The housing assembly according to claim 4, wherein the retention portion has a plurality of retention portions each protruding from the axial surface in a form of a column, a central portion of the sealing member contacting the axial surface has a plurality of openings, each of the retention portions is inserted into one of the openings so that an inner edge of each opening is in frictional contact with an outer surface of one of the retention portions.

6. The housing assembly according to claim 5, wherein the column has a polygonal or circular cross-section.

7. The housing assembly according to claim 5, wherein the column protrudes beyond the axial surface by a length greater than a thickness of the central portion of the sealing member, the retention portions are inserted into the openings with an end of the retention portions positioned outside the openings.

8. The housing assembly according to claim 5, wherein each retention portion has an enlarged head at a free end of the column, the enlarged head axially blocking the sealing member from disengaging from the retention portion, the central portion of the sealing member is between the enlarged head and the axial surface.

9. The housing assembly according to claim 8, wherein the enlarged head has a portion protruding radially from the column, a cross-sectional area of the enlarged head is larger than the opening of the sealing member.

10. The housing assembly according to claim 8, wherein the column has a quadrilateral cross-section and the enlarged head extends radially outward from three side surfaces of the column except for one side surface facing the housing body.

11. The housing assembly according to claim 8, wherein the enlarged head tapers from a radially protruding portion of the enlarged head in a direction away from the flange portion.

12. The housing assembly according to claim 2, wherein the retention portion at least partially protrudes radially outward from an outer surface of a side wall of the housing body, the sealing member surrounds at least a portion of the housing body, so that the sealing member is retained between the flange portion and the retention portion and abuts against the flange portion and the retention portion.

13. The housing assembly according to claim 12, wherein the retention portion has a pressing portion for pressing the sealing member, the retention portion is tapered from the pressing portion in a direction away from the flange portion.

14. The housing assembly according to claim 2, wherein the sealing member has at least two lips on a surface facing the mounting panel, the at least two lips include a first lip formed at an outer edge of the sealing member in a circumferential direction and a second lip positioned at a distance from the first lip.

15. The housing assembly according to claim 2, wherein the insulation housing has at least one pair of locking portions protruding from a pair of outer surfaces of two opposite side walls of the housing body towards the flange portion, the locking portions lock the mounting panel between the sealing member and the locking portions, the sealing member protrudes from an axial surface of the flange portion by a height greater than a distance between free ends of the locking portions and the axial surface, the sealing member elastically abuts against the mounting panel.

16. The housing assembly according to claim 1, wherein the sealing structure is an integral and non-removable structure integrated with the flange portion.

17. The housing assembly according to claim 16, wherein a side of the flange portion facing the mounting panel has a step that is recessed relative to an axial surface of the flange portion, the step extends along a circumferential edge of the flange portion, the sealing structure is formed on the step.

18. The housing assembly according to claim 17, wherein the insulation housing has at least one pair of locking portions extending from a pair of outer surfaces of two opposite side walls of the housing body towards the flange portion, the locking portions lock the mounting panel between the sealing structure and the locking portions, the sealing member protrudes from the axial surface of the flange portion by a height greater than a distance between free ends of the locking portions and the axial surface, the sealing member elastically abuts against the mounting panel.

19. The housing assembly according to claim 16, wherein the sealing structure is a cured-in-place gasket formed on the flange portion by in-situ curing.

20. A connector, comprising a housing assembly according to claim 1 and a terminal installed in the insulation housing of the housing assembly.
